(19) United States
(12) Patent Application Publication
(10) Pub. No.: US 2003/0112205 A1
(43) Pub. Date: Jun. 19, 2003

(54) Display apparatus with function for initializing luminance data of optical element

(75) Inventor: Kouichi Yamada, Hasima-gun (JP)

Correspondence Address: McDERMOTT, WILL & EMERY, 600 13th Street, N.W., Washington, DC, 20005-3096, US

(73) Assignee: Sanyo Electric Co., Ltd.

(21) Appl. No.: 10/319,593

(22) Filed: Dec. 16, 2002

(30) Foreign Application Priority Data
Dec. 18, 2001 (JP) JP2001-385192

(51) Int. Cl. G09G 5/10

(52) U.S. Cl. 345/32

(57) ABSTRACT

Prior to writing new luminance data in the n-th row pixel, as the (n−1)th scanning line turns high to write the luminance data in the (n−1)th row pixel, the bypass transistor and the initialization transistor of the n-th row pixel turn on. Hence, the luminance data having been set in the driving transistor is initialized, and the organic light emitting diode goes out.

### BACKGROUND OF THE INVENTION

1. Field of the Invention

The present invention relates to a display apparatus and more particularly to a technology for improving the display quality of active-matrix type display apparatuses.

2. Description of the Related Art

The use of notebook-type personal computers and portable terminals is spreading rapidly. Displays mainly used for such equipment are liquid crystal displays, but the display considered promising as a next-generation flat display panel is the organic EL (Electro Luminescence) display. And the active matrix drive system is central as a display method for such displays. The display using this system is called the active matrix display where a multiplicity of pixels are vertically and horizontally disposed in a matrix, and a switching element is provided for each pixel. Image data are written into each pixel sequentially by the switching element.

The research and development for designing practical organic EL displays is now in the pioneer days, when a variety of pixel circuits are being proposed. One example of such circuits is a pixel circuit disclosed in Japanese Patent Application Laid-Open No. 2001-60076, which will be briefly explained hereinbelow with reference to FIG. 5.

This circuit is comprised of a first transistor Tr11, a second transistor Tr12 and a third transistor Tr13 which are three n-channel transistors, an organic light emitting diode OLED which is an optical element, a storage capacitance SC11, a scanning line SL, a power supply line Vdd, a data line DL through which luminance data is inputted, and a stop control line ZL.

This circuit operates as follows. To write luminance data of the organic light emitting diode OLED, the scanning line SL turns high and the first transistor Tr11 turns on, and luminance data inputted to the data line DL is set in both the second transistor Tr12 and the storage capacitance SC11. At the timing of luminescence, the scanning line SL becomes low, thereby turning the first transistor Tr11 off and thus maintaining voltage at the gate of the second transistor Tr12, so that luminescence takes place according to the set luminance data.

Thereafter, prior to the scanning line SL becoming high at the next scanning timing, the stop control line ZL is turned high at a predetermined timing, so that the third transistor Tr13 turns on to delete the luminance data set in the second transistor Tr12. This makes it possible to adjust the display luminance of the organic light emitting diode OLED.

When the luminance data set for an optical element is large, an attempt to set smaller luminance data by rewriting the luminance data may often end in an residual image phenomenon, where an electric charge corresponding to the previous large luminance data remains in the optical element without being drained off completely and thus the desired luminance data cannot be set accurately. When this happens, images may become very hard to see especially when quickly moving pictures are to be displayed.

### SUMMARY OF THE INVENTION

The present invention has been made in view of the foregoing circumstances and an object thereof is to provide a new circuitry that can reduce the occurrence of the above-mentioned residual image phenomenon.

A preferred embodiment according to the present invention relates to a display apparatus. This apparatus includes: an optical element; a drive element, placed on a path of current flowing to the optical element, which causes desired current to flow to the optical element by controlling the current according to luminance data; a shutoff circuit which shuts off the current flowing to the optical element by controlling the drive element independently of the luminance data; and a discharging circuit which discharges electric charge accumulated across the optical element.

What may be assumed here as an optical element is an organic light emitting diode, but is not limited thereto. Moreover, what may be assumed here as a drive element is, for example, an MOS (Metal Oxide Semiconductor) transistor or a TFT (Thin Film Transistor), but is not limited thereto. “Luminance data” means data concerning luminance or brightness information to be set in the drive transistor, and is distinguished from the intensity of light emitted by the optical element. The luminance data is set to the drive element, and the operation thereof may be described also as “luminance data is written to a pixel” in this patent specifications.

In the order of optical element and drive element or vice versa, these two elements are connected in series from a fixed potential such as power-supply voltage that supplies current to the optical element. For example, where the drive element is a transistor as mentioned above, the luminance data is set in the form of a voltage at the gate electrode thereof. In this case, the transistor, which is the drive element, will turn off if the gate electrode of this transistor is connected to ground potential via a path including a switching element and this switching element is turned on to bring the potential at the gate to the same level as ground potential. At this time, the supply of current to the optical element is shut off since the drive element is connected in series with the optical element. Here, what may be assumed as the switching element is a transistor, for instance, but should not be limited thereto, and it may be any element that is capable of on-off operation.

The circuit that can be assumed as a “circuit which discharges the electric charge accumulated across the optical element” is, for instance, a bypass path that has a switching element connected in parallel with the optical element. In this circuit, the electric charge accumulated across the optical element is discharged by turning this switching element on.

This display apparatus may be so structured that the circuit to be shut off and the circuit to be discharged may be activated by a same signal. Moreover, the luminance data is set in the drive element by a scanning signal, so that the same signal may be a scanning signal utilized for an optical element to which luminance data is set immediately before the optical element in question. The “scanning signal” is a signal for controlling the on and off of the switching element, and the signal line therefor is provided individually for each pixel line. Namely, the circuit to be shut off and the circuit to be discharged may be activated by utilizing a scanning signal provided for the preceding pixel line, thus rendering it unnecessary to provide separate signal lines to control these circuits.

Another preferred embodiment according to the present invention relates to a display apparatus. This display apparatus includes: an optical element; a driving transistor, placed on a path of current flowing to the optical element, which causes a desired current to flow to the optical element by controlling the current according to luminance data; an initialization transistor which shuts off current flowing to the optical element by controlling a control voltage of the driving transistor independently of the luminance data; and a bypass transistor which discharges electric charge accumulated across the optical element, wherein the initialization transistor and the bypass transistor are activated by a scanning signal for an optical element to which luminance data is set one scanning period previously.

Still another preferred embodiment according to the present invention relates also to a display apparatus. This display apparatus includes: an optical element; a drive element which drives the optical element in accordance with set luminance data; an initialization circuit which sets, in the drive element, dummy data having no relation to the luminance data; and a discharging circuit which discharges electric charge accumulated across the optical element. Moreover, the dummy data may also be data that sets the optical element in a low-drive status.

The dummy data is set temporarily before proper luminance data is set in the drive element. For example, a value that will turn the optical element off is set as the dummy data.

It is to be noted that any arbitrary combination or rearrangement of the above-described structural components and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

FIG. 1 shows a circuit for an n-th row pixel of a certain pixel column of a display apparatus according to an embodiment of the present invention.

FIG. 2 shows circuits for three pixels of the same column of the display apparatus according to the embodiment of the present invention.

FIG. 3 is a timing chart for scanning signals in the display apparatus according to the embodiment of the present invention.

FIG. 4 shows a circuit for one pixel of the display apparatus according to a modified example based on the embodiment.

FIG. 5 shows a circuit for one pixel in a display apparatus according to a conventional art.

FIG. 6 shows a circuit for one pixel of the display apparatus according to another modified example based on the embodiment.

FIG. 7 shows a multi-layer structure of an organic light emitting diode.

FIG. 8 shows another multi-layer structure of the organic light emitting diode.

FIG. 9 shows an example of the pixel circuit suitable for the organic light emitting diode OLED having a multi-layer structure shown in FIG. 8.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the following embodiments, an active matrix organic EL (Electro Luminescence) display is assumed as a display apparatus, and an organic light emitting diode as an optical element. In these embodiments, novel circuitry that reduces the above-mentioned residual image phenomenon will be proposed. Accordingly, a bypass including a switching element is provided in parallel from the anode of an optical element to ground potential. Another switching element is also provided between a gate electrode of a driving transistor and ground potential. By turning these switching elements on and off simultaneously utilizing a scanning signal for a pixel line immediately prior thereto, luminance data set in the driving transistor is initialized, current flowing to the optical element is shut off at the same time, and also electrical charge accumulated in the optical element is discharged to turn off the optical element.

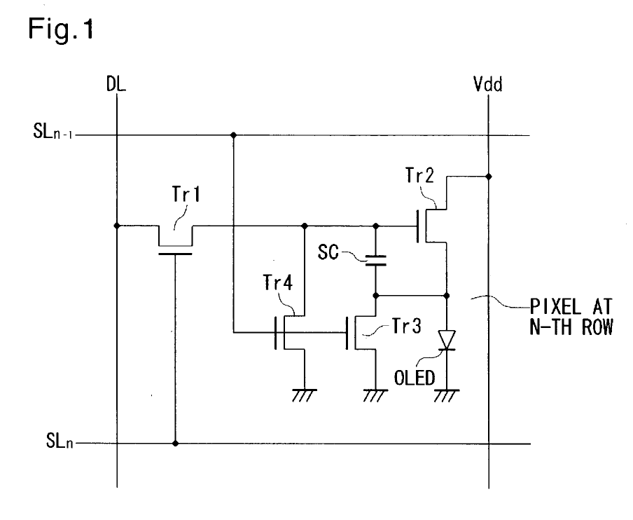

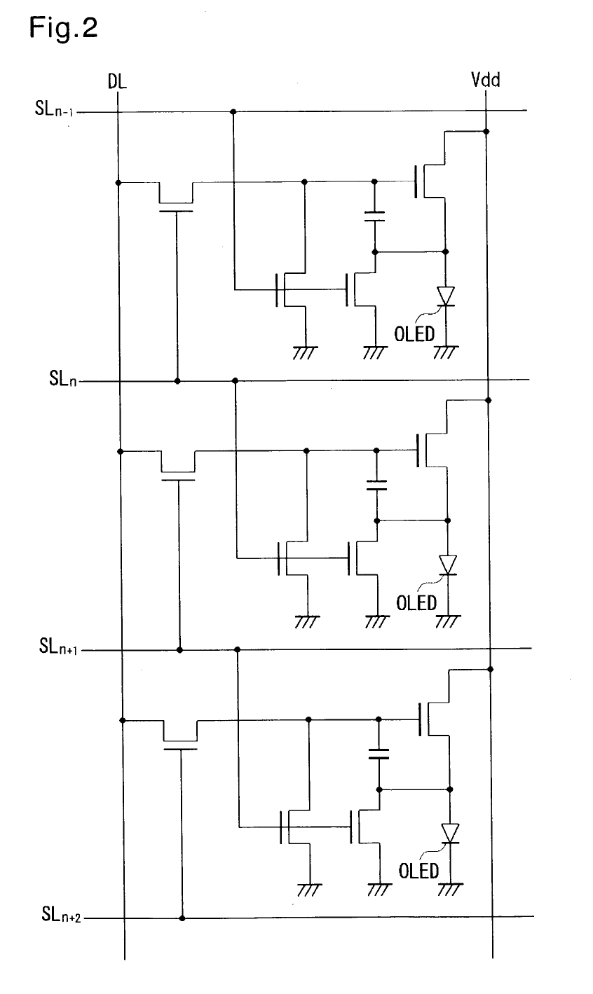

FIG. 1 shows a circuit for an n-th row pixel of a certain pixel column of a display apparatus according to a preferred embodiment of the present invention. FIG. 2 shows circuits for three pixels of the same column, namely, the n-th, (n+1)th and (n+2)th row pixels, in which some of the reference numerals are omitted. Each of these pixels is comprised of an organic light emitting diode OLED which is an optical element, a data write transistor Tr1, a bypass transistor Tr3, an initialization transistor Tr4, a driving transistor Tr2 which functions as a drive element for the organic light emitting diode OLED, and a storage capacitance SC.

The data write transistor Tr1, which functions as a switching element, turns on when a scanning signal to write luminance data is activated, and leads the luminance data to the driving transistor Tr2. The bypass transistor Tr3, which is connected in parallel with the organic light emitting diode OLED and functions also as a switching element, discharges the electric charge accumulated in the organic light emitting diode OLED. The initialization transistor Tr4, which also functions as a switching element, initializes the luminance data set in the driving transistor Tr2 and shuts off the current to be supplied to the organic light emitting diode OLED.

A power supply line Vdd supplies current to have the organic light emitting diode OLED emit light. A data line DL sends a signal of luminance data to be set in the driving transistor Tr2. An (n−1)th scanning line SLₙ₋₁ to an (n+2)th scanning line SLₙ₊₂ send scanning signals to activate (n−1)th to (n+2)th row pixels, respectively, at the timing of turning on the organic light emitting diodes OLEDs provided therein. The data write transistor Tr1, the driving transistor Tr2, the bypass transistor Tr3 and the initialization transistor Tr4 are all n-channel transistors.

A gate electrode of the data write transistor Tr1 is connected to the n-th scanning line SLₙ, whereas gate electrodes of the bypass transistor Tr3 and the initialization transistor Tr4 are connected to the (n−1)th scanning line SLₙ₋₁ for the (n−1)th row pixel (not shown). A drain electrode (or a source electrode) of the data write transistor Tr1 is connected to the data line DL. The source electrode (or the drain electrode) of the data write transistor Tr1, a drain electrode (or a source electrode) of the initialization transistor Tr4, and one of the two electrodes of the storage capacitance SC are connected to a gate electrode of the driving transistor Tr2. A drain electrode of the driving transistor Tr2 is connected to the power supply line Vdd. A source electrode of the driving transistor Tr2, an anode of the organic light emitting diode OLED, and the other electrode of the storage capacitance SC are connected to a drain electrode (or a source electrode) of the bypass transistor Tr3. The source electrodes (or the drain electrodes) of the bypass transistor Tr3 and initialization transistor Tr4 and a cathode of the organic light emitting diode OLED are each connected to ground potential. Thus, the driving transistor Tr2 and the organic light emitting diode OLED, in this order, are connected in series between the power supply line Vdd and ground potential.

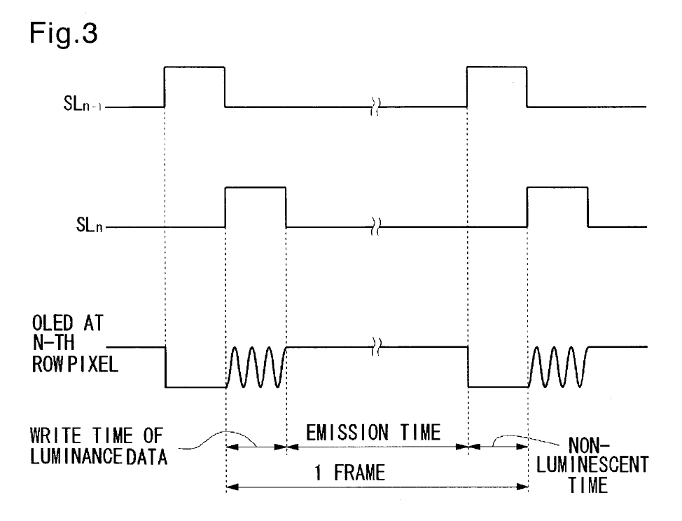

An operation by this circuit is further explained with reference to a timing chart shown in FIG. 3. With the arrival of luminance data write time, as the n-th scanning line SLₙ goes high to write luminance data in the n-th row pixel, the data write transistor Tr1 turns on and a potential corresponding to the luminance data is set in the gate electrode of the driving transistor Tr2 and the storage capacitance SC.

Then, with the arrival of emission time of the organic light emitting diode OLED, the n-th scanning line SLₙ turns low, so that the data write transistor Tr1 turns off. At this time, the bypass transistor Tr3 and the initialization transistor Tr4 are also off, so that the current corresponding to the luminance data set in the driving transistor Tr2 and the storage capacitance SC flows from the power supply line Vdd to the organic light emitting diode OLED.

Next, prior to writing new luminance data in the n-th row pixel, as the (n−1)th scanning line SLₙ turns high to write the luminance data in the (n−1)th row pixel, the bypass transistor Tr3 and the initialization transistor Tr4 of the n-th row pixel turn on. With the initialization transistor Tr4 turning on, the electric charge at the gate electrode of the driving transistor Tr2 is pulled to ground potential, the driving transistor Tr2 becomes an off state, and the current supply to this pixel is shut off. At the same time, with the bypass transistor Tr3 turning on, the electric charge at the anode of the organic light emitting diode OLED is also pulled to ground potential. Hence, the luminance data having been set in the driving transistor Tr2 is initialized, and the organic light emitting diode OLED goes out. This period is called the non-luminescent time of the organic light emitting diode OLED. During this non-luminescent time, therefore, the dummy data to turn off the organic light emitting diode OLED is set temporarily in the driving transistor Tr2.

Accordingly, one frame of a pixel is comprised of three periods of time, namely, the luminance data write time, the emission time and the non-luminescent time. Thus, the luminance data write time of the n-th row pixel coincides with the non-luminescent time of the (n+1)th row pixel.

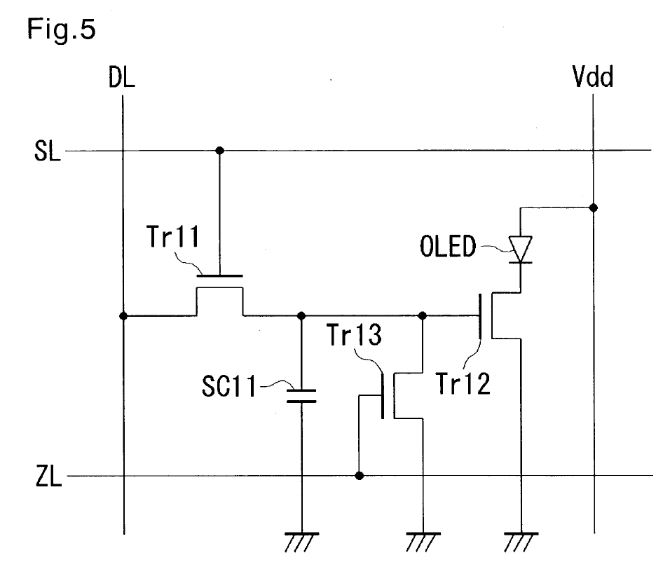

In the above preferred embodiments, prior to the writing of luminance data, the electric charge having occurred across the organic light emitting diode OLED is discharged, and the luminance data having been set in the driving transistor Tr2, which is a transistor for driving the organic light emitting diode OLED, is initialized, so that the residual image phenomenon often seen at the rewriting of large luminance data by smaller luminance data can be eliminated. Moreover, according to the conventional practice as shown in FIG. 5, the stop control line ZL is additionally provided to delete luminance data set in the second transistor Tr12. The present embodiment, in contrast thereto, differs from this conventional practice in that the scanning signal for a preceding pixel is utilized in the setting of dummy data in the driving transistor Tr2, which provides an advantage of simplifying the circuit structure. Moreover, without the stop control line ZL, there is, of course, no need for the control circuit therefor, thus realizing a saving of space.

The present invention has been described based on embodiments which are only exemplary. It is understood by those skilled in the art that there exist other various modifications to the combination of each component described above and that such modifications are encompassed by the scope of the present invention. Such modifications will be described hereinbelow.

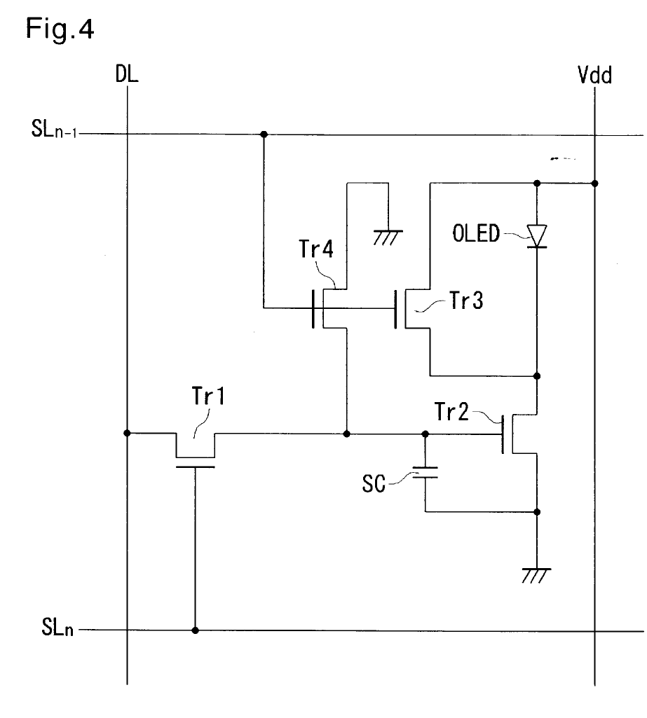

In the preferred embodiments above, the driving transistor Tr2 which is a transistor for driving the organic light emitting diode OLED is provided between the organic light emitting diode OLED and the power supply line Vdd, but the configuration therefor is not limited to this. The circuit may be so configured that, as shown in FIG. 4, the order of connection of the organic light emitting diode OLED and the driving transistor Tr2 is reversed and thus the organic light emitting diode OLED is connected to the power supply line Vdd. In this case, the bypass transistor Tr3 is connected in parallel with both ends of the organic light emitting diode OLED. Hence, whereas, in the preferred embodiment above, the potential across the organic light emitting diode OLED becomes ground potential when the bypass transistor Tr3 turns on, the potential across the organic light emitting diode OLED in this case becomes equal to that at the power supply line Vdd. The operation of this modified circuit is the same as that of the preferred embodiments above, and is omitted here.

In the preferred embodiments above, the data write transistor Tr1, the driving transistor Tr2, the bypass transistor Tr3 and the initialization transistor Tr4 are all n-channel transistors, but they may be either n-channel or p-channel transistors or combinations thereof. In such a case, however, scanning signals to control them must be signals of logic corresponding to the respective types.

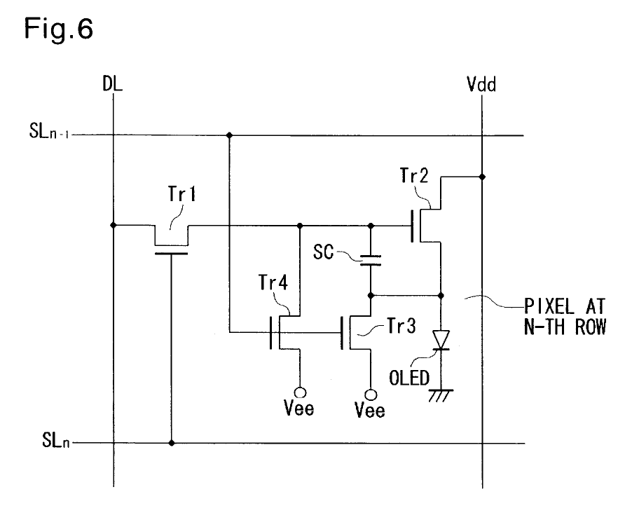

In the preferred embodiments above, the bypass transistor Tr3 is provided between the anode of the organic light emitting diode OLED and the ground potential, but is not limited thereto. The electrode of the bypass transistor Tr3 which is connected to ground potential in the embodiment may be connected to negative potential Vee as shown in FIG. 6. In such a case, the electrode of the initialization transistor Tr4 which is connected to ground potential in the embodiment will be connected to negative potential Vee. The operation by such a circuit is similar to that of the circuit shown in FIG. 1. Thus, an operation different therefrom will be mainly described here. During the non-luminescent time depicted in the embodiment, the potential at the anode of the organic light emitting diode OLD becomes equal to the negative potential Vee. Hence, the potential at the anode thereof is lower than that of the cathode thereof. Namely, the organic light emitting diode OLED is reverse-biased.

By putting the organic light emitting diode OLED in the reverse-bias applied state accordingly, the electric charge remaining in the organic light emitting diode OLED can be pulled out and the residual image phenomenon can be suppressed. At the same time, the characteristics of an organic film constituting the organic light emitting diode OLED can be recovered. As a general problem, the organic light emitting diode suffers deterioration of the organic film, namely, luminance degradation if used for long period of time, and the deterioration is conspicuous compared to other optical elements utilizing liquid crystals or the like. Thus, by setting the organic light emitting diode OLED in the reverse-bias applied state during an update period of luminance data, the display quality thereof is prevented from being reduced and at the same time the proper characteristics of the organic film can be restored.

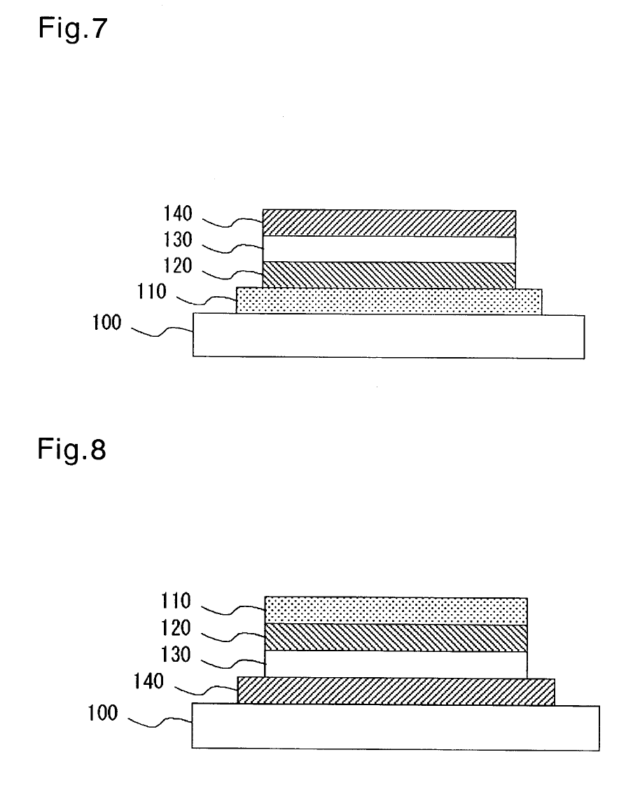

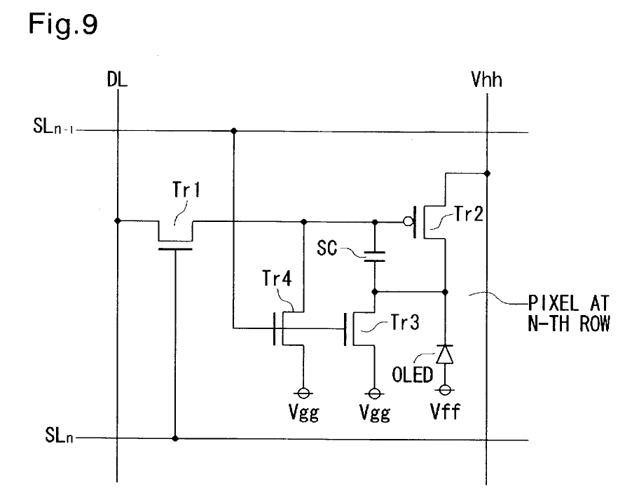

In general, a multi-layer structure of an organic light emitting diode OLED is such that an anode layer 110, a hole transporting layer 120, an organic EL layer 130 and a cathode layer 140 are stacked, in this order from the bottom to the top thereof, on an insulating substrate such as a glass substrate 100, as shown in FIG. 7. The multi-layer structure of an organic light emitting diode OLED is not limited to that shown in FIG. 7, and may be such that a cathode layer 140, an organic EL layer 130, a hole transporting layer 120 and an anode layer 110 are stacked, in this order from the bottom to the top thereof, on an insulating substrate such as a glass substrate 100, as shown in FIG. 8. If the multi-layer structure of the organic light emitting diode OLED is one as shown in FIG. 7, a cathode of the organic light emitting diode OLED is connected to ground potential which is fixed potential. If the multi-layer structure of the organic light emitting diode OLED is one as shown in FIG. 8, an anode of the organic light emitting diode OLED is connected the fixed potential. FIG. 9 is an example of the pixel circuit suitable for the organic light emitting diode OLED having such a multi-layer structure.

FIG. 9 is a circuit for a pixel where the anode and the cathode of the organic light emitting diode OLED shown in the pixel circuit of FIG. 1 are replaced with the cathode and the anode thereof, respectively, so that an anode of an organic light emitting diode OLED shown in FIG. 9 is connected to a power supply potential Vff which is both a positive potential and a fixed potential. Moreover, two electrodes, connected to the ground potential, of the bypass transistor TR3 and the initialization transistor Tr4 are now each connected to a positive potential Vgg which is higher than the power supply potential Vff. Moreover, the driving transistor TR2 is now changed to an p-channel transistor, a source electrode of the driving transistor Tr2 is now connected to a cathode of the organic light emitting diode OLED and a drain electrode of the driving transistor TR2 is now connected to a low potential line Vhh which is ground potential.

The operation by this circuit shown in FIG. 9 is substantially the same as that by the circuit shown in FIG. 1. Thus, what differs therefrom will be mainly described here. During the non-luminance time depicted in the above embodiments, the cathode of the organic light emitting diode OLED becomes positive potential Vgg, and the potential at the cathode is higher than the potential at the power supply potential Vhh which is the potential of the anode. In other words, the organic light emitting diode OLED is in a reverse-bias applied state. Moreover, in this circuit shown in FIG. 9, the low potential line Vhh which is the ground potential may be of negative potential, and the power supply potential Vff connected to the anode of the organic light emitting diode OLED may be of ground potential.

Although the present invention has been described by way of exemplary embodiments, it should be understood that many changes and substitutions may further be made by those skilled in the art without departing from the scope of the present invention which is defined by the appended claims.

What is claimed is:

1. A display apparatus, including:
an optical element;
a drive element, placed on a path of current flowing to said optical element, which causes desired current to flow to said optical element by controlling the current according to luminance data;
a shutoff circuit which shuts off the current flowing to said optical element by controlling said drive element independently of the luminance data; and
a discharging circuit which discharges electric charge accumulated across said optical element.

2. A display apparatus according to claim 1, wherein said shutoff circuit and said discharging circuit are activated by a same signal.

3. A display apparatus according to claim 2, wherein the luminance data is set to said drive element by a scanning signal, and the same signal is a scanning signal utilized for an optical element to which luminance data is set immediately prior to said optical element.

4. A display apparatus, including:
an optical element;
a driving transistor, placed on a path of current flowing to said optical element, which causes a desired current to flow to said optical element by controlling the current according to luminance data;
an initialization transistor which shuts off current flowing to said optical element by controlling a control voltage of said driving transistor independently of the luminance data; and
a bypass transistor which discharges electric charge accumulated across said optical element,
wherein said initialization transistor and said bypass transistor are activated by a scanning signal for an optical element to which luminance data is set one scanning period previously.

5. A display apparatus, including:
an optical element;
a drive element which drives said optical element in accordance with set luminance data;
an initialization circuit which sets, in said drive element, dummy data having no relation to the luminance data; and
a discharging circuit which discharges electric charge accumulated across said optical element.

6. A display apparatus according to claim 5, wherein the dummy data is data that sets said optical element in a low-drive state.

7. A display apparatus according to claim 1, wherein said drive element is a thin film transistor.

8. A display apparatus according to claim 2, wherein said drive element is a thin film transistor.

9. A display apparatus according to claim 3, wherein said drive element is a thin film transistor.

10. A display apparatus according to claim 1, wherein said discharging circuit includes a bypass path comprised of a switching element disposed in parallel with said optical element.

11. A display apparatus according to claim 2, wherein said discharging circuit includes a bypass path comprised of a switching element disposed in parallel with said optical element.

12. A display apparatus according to claim 3, wherein said discharging circuit includes a bypass path comprised of a switching element disposed in parallel with said optical element.

13. A display apparatus according to claim 7, wherein said discharging circuit includes a bypass path comprised of a switching element disposed in parallel with said optical element.

14. A display apparatus according to claim 8, wherein said discharging circuit includes a bypass path comprised of a switching element disposed in parallel with said optical element.

15. A display apparatus according-to claim 9, wherein said discharging circuit includes a bypass path comprised of a switching element disposed in parallel with said optical element.

16. A display apparatus according to claim 2, wherein the same signal is a scanning signal for an optical to which luminance data is set immediately prior to said optical element.

17. A display apparatus according to claim 3, wherein the same signal is a scanning signal for an optical to which luminance data is set immediately prior to said optical element.
